(19) United States
(12) Patent Application Publication
(10) Pub. No.: US 2017/0185581 A1
(43) Pub. Date: Jun. 29, 2017

(54) SYSTEMS AND METHODS FOR SUGGESTING EMOJI

(71) Applicant: Machine Zone, Inc., Palo Alto, CA (US)

(72) Inventors: Nikhil Bojja, Mountain View, CA (US); Satheeshkumar Karuppusamy, San Jose, CA (US); Pidong Wang, Mountain View, CA (US); Shivasankari Kannan, Sunnyvale, CA (US); Arun Nedunchezhian, Milpitas, CA (US)

(21) Appl. No.: 15/384,950

(22) Filed: Dec. 20, 2016

Related U.S. Application Data
(60) Provisional application No. 62/272,324, filed on Dec. 29, 2015.

(51) Int. Cl. G06F 17/27; G06F 17/24; G06F 17/28

(52) U.S. Cl. CPC G06F 17/276; G06F 17/2735; G06F 17/2809; G06F 17/24; G06F 17/2765

(57) ABSTRACT

Implementations of the present disclosure are directed to a method, a system, and an article for suggesting emoji for insertion into a communication having text or other content. A plurality of features corresponding to the communication are obtained and provided to a plurality of emoji detection modules. A set of emoji and first confidence scores are received from each emoji detection module and provided to at least one classifier. A proposed set of candidate emoji and second confidence scores are received from the at least one classifier. A candidate emoji is inserted into the communication.

### CROSS-REFERENCE TO RELATED APPLICATIONS

This application claims priority to U.S. Provisional Patent Application No. 62/272,324, filed Dec. 29, 2015, the entire contents of which are incorporated by reference herein.

### BACKGROUND

The present disclosure relates to language detection and, in particular, to systems and methods for suggesting emoji.

In general, emoji are images, graphical symbols, or ideograms typically used in electronic messages and communications to convey emotions, thoughts, or ideas. Emoji are available for use through a variety of digital devices (e.g., mobile telecommunication devices and tablet computing devices) and are often used when drafting personal e-mails, posting messages on the Internet (e.g., on a social networking site or a web forum), and messaging between mobile devices.

The number of emoji a user can choose from has grown vastly in recent years. There are emoji available for almost every subject matter imaginable. Due to the expansion in number, usage, availability, and variety of emoji, it can be time consuming, and sometimes overwhelming, for users to browse through and select appropriate emoji for a given context when participating in emoji-applicable computing activities.

### SUMMARY

Implementations of the systems and methods described herein can be used to suggest one or more emoji to users for insertion into, or to replace content in, documents and electronic communications. Content can include text (e.g., words, phrases, abbreviations, characters, and/or symbols), emoji, images, audio, video, and combinations thereof. Alternatively, implementations of the systems and methods described herein can be used to automatically insert emoji into content or replace portions of content with emoji without requiring user input. For example, content can be analyzed by the system as a user types or enters the content and, based on the analysis, the system can provide emoji suggestions to the user in real-time or near real-time. A given emoji suggestion can include one or more emoji characters that, if selected, will be inserted into the content to replace a portion of the content. The user may then select one of the emoji suggestions, and the emoji of the suggestion can be inserted into the content at the appropriate location (e.g., at or near a current input cursor position) or can replace a portion of the content.

In various examples, the systems and methods use one or more emoji detection methods and classifiers to determine probabilities or confidence scores for emoji. The confidence scores represent a likelihood that a user will want to insert the emoji into a particular content or replace the particular content (or a portion thereof) with the emoji. For example, emoji having the highest confidence scores can be suggested to the user for possible insertion into a text message. In some instances, each emoji detection method outputs a set or vector of probabilities associated with the possible emoji. The classifiers can combine the output from the emoji detection methods to determine a set of suggestions for the content. Each suggestion can contain one or more emoji. The particular emoji detection method(s) and classifier(s) chosen for the message can depend on a predicted accuracy, a confidence score, a user preference, a linguistic domain for the message, and/or other suitable factors. Other ways of selecting the detection method(s) and/or classifier(s) are possible.

In certain examples, the systems and methods described herein convert content to emoji in real-time. This process is referred to as “emojification.” As a user enters content, for example, the content can be analyzed to identify and provide emoji suggestions. Users may communicate with one another through a combination of text and emoji, with emoji suggestions being offered as users enter or type messages. The mixture of text and emoji provides a new communication paradigm that can serve as a messaging platform for use with various clients and for various purposes, including gaming, text messaging, and chat room communications.

Users can have the option of toggling between messages with and without emoji. For example, a user can select an “emojify” command in a text messaging system that toggles between plain text and text with emoji characters (i.e., an “emojified” version of text). The toggling feature can accommodate user preferences and allow them to more easily choose between plain text and text with emoji. The feature can also be used to convert content to emoji (i.e., emojify) in larger portions of content (e.g., entire text message conversations), which might generate a different output (e.g., given more information about the topic of conversation) than would be generated when smaller portions (e.g., individual words or sentences) of the content are converted to emoji. Emoji can also be used as an alternative to language translation for messages that are difficult to translate or when the translation quality for a particular message is not acceptable.

The insertion or use of emoji can be particularly suited to gaming environments. Chat communication is an important player retention feature for certain games. Use of emoji as a communication protocol can enhance the gaming experience and make players more engaged in the game and in communications with other players.

In one aspect, the subject matter described in this specification is embodied in a method of suggesting emoji. The method includes performing, by one or more computers, the following: obtaining a plurality of features corresponding to a communication from a user; providing the features to a plurality of emoji detection modules; receiving from each emoji detection module a respective output including a set of emoji and first confidence scores, each first confidence score being associated with a different emoji in the set and representing a likelihood that the user may wish to insert the associated emoji into the communication; providing the output from the emoji detection modules to at least one classifier; receiving from the at least one classifier a proposed set of candidate emoji and second confidence scores, each second confidence score being associated with a different candidate emoji in the proposed set and representing a likelihood that the user may wish to insert the associated candidate emoji into the communication; and inserting at least one of the candidate emoji into the communication.

In certain examples, the plurality of features include a current cursor position in the communication, one or more words from the communication, one or more words from the previous communication, a user preference, and/or demographic information. The emoji detection modules can include a grammar error correction module, a statistical machine translation module, a dictionary-based module, an information extraction module, a natural language processing module, a keyword matching module, and/or a finite state transducer module. In one example, the dictionary-based module is configured to map at least a portion of a word in the communication to at least one corresponding emoji.

In some implementations, the natural language processing module includes a parser, a morphological analyzer, and/or a semantic analyzer to extend a mapping between words and emoji provided by the dictionary-based module. Alternatively or additionally, the keyword matching module can be configured to search for at least one keyword in the communication and match the at least one keyword with at least one tag associated with emoji. In some examples, the first confidence scores and/or the second confidence scores can be based on a user preference, a linguistic domain, demographic information, prior usage of emoji by at least one of the user and a community of users, and/or prior usage of emoji in prior communications having at least one of a word, a phrase, a context, and a sentiment in common with the communication.

In certain implementations, the at least one classifier includes a supervised learning model, a partially supervised learning model, an unsupervised learning model, and/or an interpolation model. The at least one of the candidate emoji can be inserted at the current cursor position and can replace at least one word in the communication. In some instances, inserting the at least one of the candidate emoji includes identifying a best emoji having a highest second confidence score in the proposed set of candidate emoji. The method can also include receiving a user selection of at least one of the candidate emoji from the proposed set of candidate emoji, and building a usage history based on the user selection. In some examples, the method also includes selecting the at least one classifier based on the user preferences and/or the demographic information. The plurality of emoji detection modules can perform operations simultaneously.

The method can include augmenting a dictionary for the dictionary-based module by calculating cosine similarities between vector representations of two or more words. For example, the method can include: obtaining vector representations for two or more words; calculating cosine similarities for the vector representations; and augmenting a dictionary (e.g., for the dictionary-based module) based on the cosine similarities between words and/or phrases.

In another aspect, the subject matter described in this specification can be embodied in a system that includes one or more processors programmed to perform operations including: obtaining a plurality of features corresponding to a communication from a user; providing the features to a plurality of emoji detection modules; receiving from each emoji detection module a respective output including a set of emoji and first confidence scores, each first confidence score being associated with a different emoji in the set and representing a likelihood that the user may wish to insert the associated emoji into the communication; providing the output from the emoji detection modules to at least one classifier; receiving from the at least one classifier a proposed set of candidate emoji and second confidence scores, each second confidence score being associated with a different candidate emoji in the proposed set and representing a likelihood that the user may wish to insert the associated candidate emoji into the communication; and inserting at least one of the candidate emoji into the communication.

In certain examples, the plurality of features include a current cursor position in the communication, one or more words from the communication, one or more words from a previous communication, a user preference, and/or demographic information. The emoji detection modules can include a grammar error correction module, a statistical machine translation module, a dictionary-based module, an information extraction module, a natural language processing module, a keyword matching module, and/or a finite state transducer module. In one example, the dictionary-based module is configured to map at least a portion of a word in the communication to at least one corresponding emoji.

In some implementations, the natural language processing module includes a parser, a morphological analyzer, and/or a semantic analyzer to extend a mapping between words and emoji provided by the dictionary-based module. Alternatively or additionally, the keyword matching module can be configured to search for at least one keyword in the communication and match the at least one keyword with at least one tag associated with emoji. In some examples, the first confidence scores and/or the second confidence scores can be based on a user preference, a linguistic domain, demographic information, prior usage of emoji by at least one of the user and a community of users, and/or prior usage of emoji in prior communications having at least one of a word, a phrase, a context, and a sentiment in common with the communication.

In certain implementations, the at least one classifier includes a supervised learning model, a partially supervised learning model, an unsupervised learning model, and/or an interpolation model. The at least one of the candidate emoji can be inserted at the current cursor position and can replace at least one word in the communication. In some instances, inserting the at least one of the candidate emoji includes identifying a best emoji having a highest second confidence score in the proposed set of candidate emoji. The operations can also include receiving a user selection of at least one of the candidate emoji from the proposed set of candidate emoji, and building a usage history based on the user selection. In some examples, the operations also include selecting the at least one classifier based on the user preferences and/or the demographic information. The plurality of emoji detection modules can perform operations simultaneously.

In another aspect, the subject matter described in this specification can be embodied in an article. The article includes a non-transitory computer-readable medium having executable instructions. The executable instructions are executable by one or more processors to perform operations including: obtaining a plurality of features corresponding to a communication from a user; providing the features to a plurality of emoji detection modules; receiving from each emoji detection module a respective output including a set of emoji and first confidence scores, each first confidence score being associated with a different emoji in the set and representing a likelihood that the user may wish to insert the associated emoji into the communication; providing the output from the emoji detection modules to at least one classifier; receiving from the at least one classifier a proposed set of candidate emoji and second confidence scores, each second confidence score being associated with a different candidate emoji in the proposed set and representing a likelihood that the user may wish to insert the associated candidate emoji into the communication; and inserting at least one of the candidate emoji into the communication.

In certain examples, the plurality of features include a current cursor position in the communication, one or more words from the communication, one or more words from the previous communication, a user preference, and/or demographic information. The emoji detection modules can include a grammar error correction module, a statistical machine translation module, a dictionary-based module, an information extraction module, a natural language processing module, a keyword matching module, and/or a finite state transducer module. In one example, the dictionary-based module is configured to map at least a portion of a word in the communication to at least one corresponding emoji.

In some implementations, the natural language processing module includes a parser, a morphological analyzer, and/or a semantic analyzer to extend a mapping between words and emoji provided by the dictionary-based module. Alternatively or additionally, the keyword matching module can be configured to search for at least one keyword in the communication and match the at least one keyword with at least one tag associated with emoji. In some examples, the first confidence scores and/or the second confidence scores can be based on a user preference, a linguistic domain, demographic information, prior usage of emoji by the user and/or a community of users, and/or prior usage of emoji in prior communications having a word, a phrase, a context, and/or a sentiment in common with the communication.

In certain implementations, the at least one classifier includes a supervised learning model, a partially supervised learning model, an unsupervised learning model, and/or an interpolation model. The at least one of the candidate emoji can be inserted at the current cursor position and can replace at least one word in the communication. In some instances, inserting the at least one of the candidate emoji includes identifying a best emoji having a highest second confidence score in the proposed set of candidate emoji. The operations can also include receiving a user selection of at least one of the candidate emoji from the proposed set of candidate emoji and building a usage history based on the user selection. In some examples, the operations also include selecting the at least one classifier based on the user preferences and/or the demographic information. The plurality of emoji detection modules can perform operations simultaneously.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for suggesting emoji for insertion into a user communication.

FIG. 2 is a flowchart of an example method of suggesting emoji for insertion into a user communication.

FIG. 3 is a schematic diagram of an example emoji detection module.

FIG. 4 is a schematic diagram of an example emoji classifier module.

FIG. 5 is a schematic diagram of an emoji suggestion system architecture.

### DETAILED DESCRIPTION

In general, systems and methods described herein can be used to suggest emoji to users for insertion into content or to replace one or more portions of the content. The given content can be within an electronic document, an electronic message, or other electronic communication. The communication can contain text content and, optionally, other content types such as, for example, images, emoji, audio recordings, multimedia, GIFs, video, and/or computer instructions.

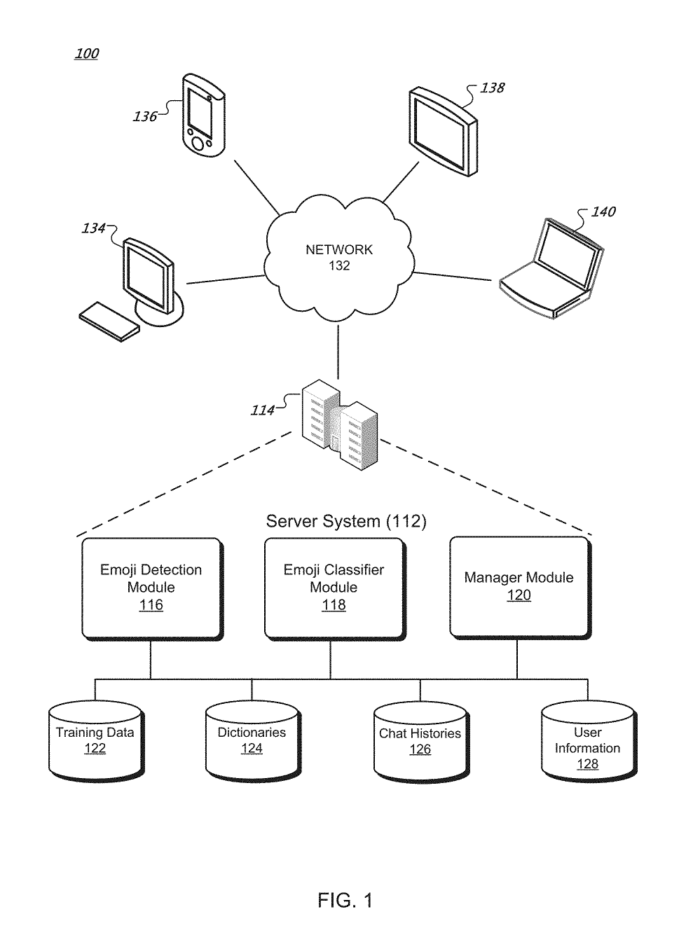

FIG. 1 illustrates an example system 100 for identifying emoji for a given content. A server system 112 provides message analysis and emoji suggestion functionality. The server system 112 includes software components and databases that can be deployed at one or more data centers 114 in one or more geographic locations, for example. The server system 112 software components can include an emoji detection module 116, an emoji classifier module 118, and a manager module 120. The software components can include subcomponents that can execute on the same or on different individual data processing apparatus. The server system 112 databases can include training data 122, dictionaries 124, chat histories 126, and user information 128. The databases can reside in one or more physical storage systems. The software components and data will be further described below.

An application such as a web-based application can be provided as an end-user application to allow users to interact with the server system 112. The end-user applications can be accessed through a network 132 (e.g., the Internet) by users of client devices, such as a personal computer 134, a smart phone 136, a tablet computer 138, and a laptop computer 140. Other client devices are possible. In alternative examples, the dictionaries 124, the chat histories 126, and/or the user information 128, or any portions thereof, can be stored on one or more client devices. Additionally or alternatively, software components for the system 100 (e.g., the emoji detection module 116, the emoji classifier module 118, and/or the manager module 120) or any portions thereof can reside on or be used to perform operations on one or more client devices.

FIG. 1 depicts the emoji classifier module 118 and the manager module 120 as being able to communicate with the databases (e.g., training data 122, dictionaries 124, chat histories 126, and user information 128). The training data 122 database generally includes training data that may be used to train one or more emoji detection methods and/or classifiers. The training data may include, for example, a set of words or phrases (or other content) along with preferred emoji that may be used to replace the words or phrases and/or be inserted into the words or phrases. The training data can also include, for example, user-generated emoji along with descriptive tags for such emoji. Furthermore, these emoji-tag combinations can include custom weights from users who might vote up certain combinations as more relevant or popular than others. The dictionaries 124 database may include a dictionary that relates words, phrases, or portions thereof to one or more emoji. The dictionary may cover more than one language and/or multiple dictionaries may be included in the dictionaries 124 database to cover multiple languages (e.g., a separate dictionary for each language). The chat histories 126 database may store previous communications (e.g., text messages) that were exchanged among users. Alternatively or additionally, the chat histories 126 database can contain information about past usage of emoji by users, including, for example, whether the users selected one or more emoji suggestions and/or the resultant emoji suggested by the automated system 112. Information related to selection based on rank ordering of emoji suggestions may be stored. The user information 128 database may include demographic information (e.g., age, race, ethnicity, gender, income, residential location, etc.) for users, including both senders and recipients. The user information 128 database may include certain user emoji preferences, such as settings that define the instances when emoji are to be used or are not to be used, any preferences for automatic emoji insertion, and/or any preferred emoji types (e.g., facial expressions or animals) that users may have. In general, the emoji classifier module 118 receives input from the emoji detection module 116, and/or the manager module 120 receives input from the emoji classifier module 118.

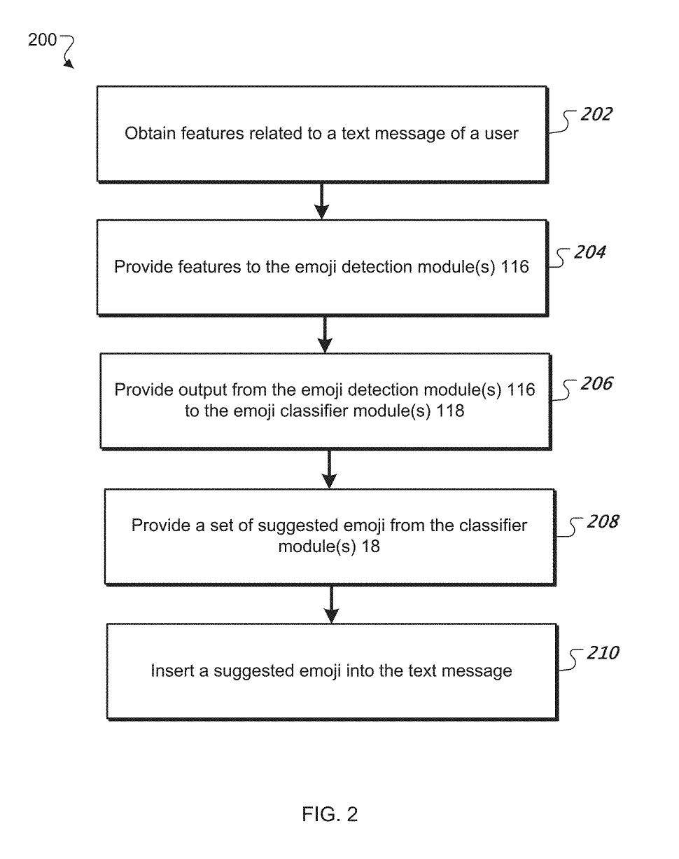

FIG. 2 illustrates an example method 200 that uses the system 100 to suggest emoji for insertion into a communication. The method 200 begins by obtaining (step 202) features associated with a communication (e.g., an electronic message) of a user. The features can include, for example, a cursor position in the content, one or more words from the communication, one or more words from a previous communication, a user preference (e.g., preferred instances when emoji are to be used, preferred specific emoji, preferred types of emoji, or preferred categories of emoji), and/or demographic information (e.g., an age, gender, ethnicity, income, or citizenship of the user and/or a recipient). Other suitable features are possible. The features are provided (step 204) to the emoji detection module 116, which preferably employs a plurality of emoji detection methods to identify candidate emoji that might be appropriate for the communication. Output from the emoji detection module 116 is provided (step 206) to the emoji classifier module 118, where one or more classifiers process the output from the emoji detection module and provide (step 208) suggested emoji for the communication. The suggested emoji can be identified with the assistance of the manager module 120, which can select particular emoji detection methods and/or classifiers to use based on various factors, including, for example, a linguistic domain (e.g., gaming, news, parliamentary proceedings, politics, health, travel, web pages, newspaper articles, and microblog messages), a language used in the communication, one or more user preferences, and the like. The linguistic domain may define or include, for example, words, phrases, sentence structures, or writing styles that are unique or common to particular types of subject matter and/or to users of particular communication systems. For example, gamers may use unique terminology, slang, or sentence structures when communicating with one another in a game environment, whereas newspaper articles or parliamentary proceedings might have a more formal tone with well-structured sentences and/or different terminology. Finally, at least one of the suggested emoji is inserted (step 210) into the communication. The emoji can be inserted into the communication automatically and/or be selected by the user for insertion. The inserted emoji can replace one or more words or phrases in the communication.

In some implementations, the suggested emoji from the one or more classifiers can be selected by the manager module 120 according to a computed confidence score. For example, the classifiers can compute a confidence score for each suggested emoji or set of emoji. The confidence score can indicate a predicted likelihood that the user will wish to insert at least one of the suggestions into the communication. Additionally or alternatively, certain classifier output can be selected according to the linguistic domain associated with the user or the content. For example, when a user message originated in a computer gaming environment, a particular classifier output can be selected as providing the most accurate emoji suggestions. Likewise, if the message originated in the context of sports (e.g., regarding a sporting event), a different classifier output can be selected as being more appropriate for the sports linguistic domain. Other possible linguistic domains can include, for example, news, parliamentary proceedings, politics, health, travel, web pages, newspaper articles, microblog messages, and other suitable linguistic domains. In general, certain emoji detection methods or combinations of emoji detection methods (e.g., from a classifier) can be more accurate for certain linguistic domains when compared to other linguistic domains. In some implementations, the linguistic domain can be determined based on the presence of words from a domain vocabulary in a message. For example, a domain vocabulary for computer gaming could include common slang words used by gamers. In some instances, sequences of words or characters are modeled to create a linguistic domain profile, so that if a given sequence of words or characters has a high probability of occurrence in a certain linguistic domain, the linguistic domain may be selected. Alternatively or additionally, the linguistic domain may be determined according to an environment (e.g., gaming, sports, news, etc.) in which the communication system is being used.

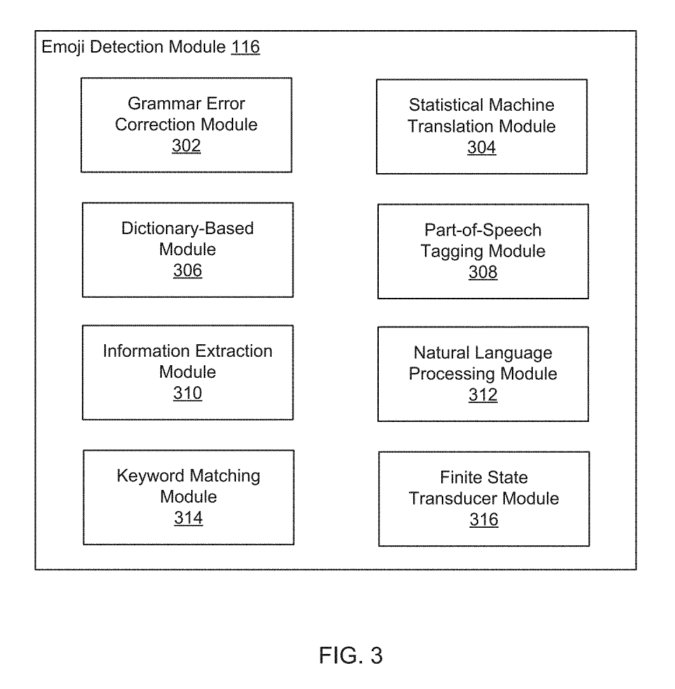

Referring to FIG. 3, the emoji detection module 116 can include or utilize a plurality of modules that perform various methods for identifying emoji suggestions. The emoji detection modules can include, for example, a grammar error correction module 302, a statistical machine translation module 304, a dictionary-based module 306, a part-of-speech (POS) tagging module 308, an information extraction module 310, a natural language processing module 312, a keyword matching module 314, and/or a finite state transducer (FST) module 316.

In general, the grammar error correction module 302 employs techniques that are similar to those used for automatic grammar error correction, except the techniques in this case are customized to identify emoji rather than correct grammar errors. In certain examples, grammar error correction methods parse an input sentence to determine the parts of speech of individual words, then determine the grammatical correctness of the system based on the linguistic rules that govern a given language. Deviations from grammatical correctness are then corrected by substitution. A record of known deviations from grammatical correctness can be created by manual input or by automated means. For example, automated methods can involve training a language parser for a given language which then gives a score of grammatical correctness based on human defined inputs. The grammar error correction module 302 can suggest emoji at real-time or near real-time for words or phrases and can suggest emoji while users are typing or entering messages, for example. As an illustration of this approach, an example incorrect sentence of “It rains of cats and dogs” may be autocorrected using grammar correction to “It's raining cats and dogs.” Such transformation may be achieved by analyzing the grammatical structure of the sentence and making corrections so that the sentence complies with known constructs of English grammar. Similar transformation effects are taught to the grammar error correction module 302 to transform text to emoji using underlying language constructs. For instance, without considering grammatical structure, the phrase “I love you” could be transformed to “I [symbol] ” (e.g., the word “I” followed by a heart emoji and a pointed finger emoji). Taking grammatical structure into consideration (e.g., two subjects and a verb), however, the phrase can be transformed to a more appropriate emoji representation that represents two subjects and a verb, such as “ [symbol] ” (e.g., an emoji having a heart shape between two people). In this way, rather than transforming bad grammar to good grammar, as in the previous example, the grammar error correction module 302 is able to transform text or sentences to one or more emoji.

In some implementations, the grammar error correction module 302 can employ multiple classifiers. In one example, the grammar error correction module 302 can use supervised classifiers that are trained using annotated training data. Data obtained from crowdsourcing can be used to further train the classifiers. By way of illustration, users can be incentivized (e.g., with virtual goods or currency for use in an online game) to participate in the crowdsourcing and to provide training data. Content that is able to be converted to emoji or “emojified” should be considered or given priority for this training process. For example, “I am good” may not be helpful for training, while “I am good lol” may be helpful for training and should be given priority.

In some instances, users can annotate chat messages to indicate which phrases can or should be replaced with emoji. For example, given the phrase “i like it lol u?,” a user can indicate that “lol” should be replaced with a smiley-face emoji, such as “ [symbol] ”. These annotated messages can also be used as training data.

The grammar error correction module 302 and other modules described herein can be used to determine if a phrase should be emojified in a specific way. To make this determination, phrases that can be emojified into one or more emoji can be identified. A dictionary collected from training data can be used to map these phrases to a list of emoji. For example, the word “star” can be mapped to an image of a yellow star or an image of a red star (e.g., “ [symbol] ” or “ [symbol] ”). Identified phrases may overlap or be mapped to the same emoji in some instances. A classifier trained on the training data can then be used to determine how to emojify phrases obtained from user communications. For example, the word “star” can be mapped to an image of a yellow star “ [symbol] ” in one instance, and an image of a red star “ [symbol] ” in a different instance. In some implementations, the classifier can be a binary classifier that provides a yes or no for each instance. An emojified message or emoji suggestions can be output based on the classifier results.

The statistical machine translation (SMT) module 304 can employ SMT methods (e.g., MOSES or other suitable SMT methods) to transform chat messages into their respective emoji representations (i.e., their “emojified” forms). A parallel corpus containing chat messages and their emojified forms can be utilized. For example, the parallel corpus can contain the message “i like it lol u?” and the emojified form can be “i like it [symbol] u?,” in which “lol” has been replaced with a smiley-face emoji. The training data can be based on data used for the grammar error correction module 302. In some examples, multiple parallel sentences of text and emoji are aligned to extract the most commonly occurring pairs of phrases and emoji. A probability distribution is then built on top of these phrase pairs based on the frequency of occurrence and the context in which they appear. A Hidden Markov Model (HMM) or similar model can then be trained on such phrase pairs to learn the most efficient state transitions when generating emoji versions of a sentence. In one example, the HMM model contains each word as a different state, and state transitions are representative of word sequences. For example, the sequence “snow storm” has a higher frequency of occurrence in the English language than “snow coals.” A generative algorithm like HMM, when looking to produce an output sentence from a given input, looks for a certain probability to transit from a given state and generate next words. Hence, in English, the word/state “snow” is more likely to be followed by “storm” than “coals,” because the probability of “storm” following “snow” is higher than the probability of “coals” following “snow.” Such modeling may be referred to as language modeling. In certain examples, a language model trained on emoji text is used in conjunction with the HMM model to generate language converted to emoji from plain text.

In some instances, the SMT module 304 can be used to suggest emoji as users are inputting text or other content to a client device. To train the SMT module for such emoji suggestions, training data can be provided for each stage of suggestion. As an example, for the emojification pair “I am laughing” [symbol] “I am [symbol] ” the following training examples could be generated and used to train the SMT module 304: “I am l” [symbol] “I am [symbol] ”; “I am la” [symbol] “I am [symbol] ”; “I am lau” [symbol] “I am [symbol] ” etc. Such training examples can enable the SMT module 304 to recognize or predict an intended text message based on partial user input and/or to suggest emoji or emojified text based on the partial user input.

In certain examples, a synchronous pipeline can be established and configured for providing a sequence of words or other sentence fragments from a client device to a server, for example, as the words are being typed by a user of the client device. The pipeline can provide a secure and efficient mechanism for data transfer between the client device and the server. A frequency of server pings can be defined to provide optimal data transfer. In one example, a phrase table can be downloaded to a client device and lattice decoding can be used to do emojification. Memory optimization and/or decoding optimization on the client side may be helpful in such instances.

The SMT module 304 can be trained with a parallel corpus having plain text on one end and emojified text on the other end. The phrase table produced in this manner can be used to extract word/phrase-emoji pairs and/or to enhance one or more dictionaries for emoji suggestion (e.g., for use with the dictionary-based module 306). In one instance, this approach improved an F₁ score for emoji suggestion by 13%.

The dictionary-based module 306 preferably uses a dictionary to map words or phrases to corresponding emoji. For example, the phrase “lol” can be mapped to “ [symbol] ”. The dictionary can be constructed manually and/or developed through the use of crowdsourcing, which can be incentivized. Some dictionary implementations can include less than 1,000 emoji, and not all emoji have a single corresponding word or any corresponding word.

The dictionary used in the dictionary-based module 306 preferably maps words or phrases to emoji with little or no ambiguity. As an example, the dictionary should not necessarily map the word “right” to an emoji representing “correct” (e.g., a check-mark emoji, such as “ [symbol] ”). Although the phrase “u r right” is accurately emojified to “u r [symbol] ” it is not accurate to emojify the phrase “I want it right now” to “I want it [symbol] now.” The dictionary-based module 306 can lack the context information required to disambiguate the senses of a phrase.

In some examples, a deep learning-based algorithm (e.g., WORD2VEC or other suitable algorithm) can be used to determine or identify relationships between words, phrases, and emoji. The deep learning-based algorithm can map words into a vector space, in which each word is represented by a vector. A length of the vectors can be, for example, about 40, about 50, or about 60, although any suitable length is possible. To determine a relationship between words, a dot product of the vectors representing the words can be calculated. When two words (e.g., “happy” and “glad”) are similar, for example, the vectors for the two words will be aligned in the vector space, such that the dot product of the two vectors will be positive. In some examples, the vectors are normalized to have a magnitude near one, such that a dot product of two aligned vectors will also have a magnitude near +1. Normalized vectors that are substantially orthogonal (e.g., for words that are not related) can have a dot product magnitude near zero. Likewise, for words that have opposite meanings, the dot product of normalized vectors may be near −1.

The deep learning-based algorithm can be used as an enhancement for one or more dictionaries of word/phrase-emoji pairs and/or can be used to augment or improve one or more existing dictionaries. For example, when a user enters a new word that is not present in a dictionary, the algorithm can be used to find a corresponding word in the dictionary that is similar to the new word, and any emoji associated with the corresponding word can be recommended to the user based on the similarity. Alternatively or additionally, the algorithm can be used to build a more complete and/or accurate dictionary for use with the dictionary-based module 306. The algorithm can be used to add new words to a dictionary and to associate emoji with the new words, based on similarities or differences between the new words and existing words already present in the dictionary and associated with emoji.

A similar vector representation approach can be used for phrases, sentences, or other groups of words, such that similarities or differences between groups of words can be determined (e.g., using the dot product calculation). A vector can be a numerical representation of a word, phrase, sentence, document, or other grouping of words. For instance, a message m1 “Can one desire too much a good thing?” and a message m2 “Good night, good night! Parting can be such a sweet thing” can be arranged in a matrix in a feature space (can, one, desire, too, much, a, good, thing, night, parting, be, such, sweet), as shown in Table 1.

TABLE 1
Feature space for messages m1 and m2 showing a number
of occurrences of words in messages m1 and m2.

| Word | m1 | m2 |
|---|---|---|
| can | 1 | 1 |
| one | 1 | 0 |
| desire | 1 | 0 |
| too | 1 | 0 |
| much | 1 | 0 |
| a | 1 | 1 |
| good | 1 | 2 |
| thing | 1 | 1 |
| night | 0 | 2 |
| parting | 0 | 1 |
| be | 0 | 1 |
| such | 0 | 1 |
| sweet | 0 | 1 |

In this example, columns two and three in Table 1 can be used to generate vectors representing the two messages m1 and m2 and/or the words present in the messages m1 and m2. The message m1 can be represented by a vector [1111111100000], for example, which includes the values from the second column of Table 1. The message m2 can be represented by a vector [1000012121111], which includes the values from the third column of Table 1. Additionally, the word “good” in the message m1 can be represented by a vector [0000001000000], which has a length (i.e., 13) equal to the number of words present in messages m1 and m2. This vector also has a value of 1 at element 7, corresponding to the location of “good” in the vector for m1, and a value of zero in all other locations, corresponding to the locations of other words in the vector for m1. Likewise, the word “good” in the message m2 can be represented by a vector [0000002000000], in which the value of 2 indicates the word “good” appears twice in the message m2. The word “night” in the message m1 can be represented by a vector [0000000000000], in which the all zero elements indicate “night” is not present in the message m1. The word “night” in the message m2 can be represented by a vector [0000000020000], in which the value of 2 indicates the word “night” appears twice in the message m2. Other representations of words or groups of words using word vectors are possible. For instance, a message can be represented by an average of vectors (a “mean representation vector”) of all the words in the message, instead of a summation of all words in the message.

In general, a degree of similarity between two vectors A and B (e.g., representing words or groups of words) can be determined from, for example, a cosine similarity, given by A•B/(|A| |B|), where A•B is a dot product of vectors A and B, and ∥A∥ and ∥B∥ are magnitudes of vector A and vector B, respectively. The cosine similarity can be expressed as the dot product of A's unit vector (A/∥A∥) and B's unit vector (B/∥B∥). As an example, a positive cosine similarity (e.g., near +1) between vectors A and B can indicate that the word or group of words represented by vector A are similar in meaning or attribute (e.g., sentiment) to the word or group of words represented by vector B. A negative cosine similarity (e.g., near −1), by contrast, between vectors A and B can indicate that the word or group of words represented by vector A are opposite in meaning or attribute to the word or group of words represented by vector B. Additionally, a cosine similarity near zero can indicate that the word or group of words represented by vector A are not related in meaning or attribute to the word or group of words represented by vector B.

The part-of-speech (POS) tagging module 308 can be used to provide disambiguation. For example, a dictionary in the dictionary-based module 306 can be modified to include POS tags, such as Noun Phrases, Verb Phrases, Adjectives, etc., and/or additional information such as a total number of POS tags (e.g., per word) and a valid set of POS tags (i.e., a set of tags for which a word can be emojified). This allows the words in a sentence or phrase to be screened for possible emojification. Noun Phrases, if identified successfully by a Part of Speech Tagger, can be potentially bunched together at the phrase level and be replaced by relevant emoji. As an example, for the sentence “The Police Car sped along the road,” a POS tagger would identify “The Police Car” and “the road” as Noun Phrases and “sped along” as a Verb Phrase. The systems and methods may then select one emoji depicting the Police Car instead of identifying two separate emoji for Police and Car.

As a next level of disambiguation, words with the same POS tags can have multiple, non-similar meanings. For example, the term “right” in “I think she is right” and in “walk at your right hand side” is an adjective but has a different meaning and can be emojified differently in each phrase. Such cases can be handled by identifying context words from, for example, an English chat history. The context information may be added to the dictionary (e.g., through hand-collection) or created as a separate dictionary. The context approach handles both inclusion and exclusion (i.e., the words whose presence/absence will decide on emojification). The context information can be collected and stored for the most frequent co-occurrences of words.

In certain applications, a stemmer or stemming algorithm can be incorporated into or used by the dictionary-based module 306 or any other method used by the emoji detection module 116 to identify the root or base form of words in content. The stemmer can be used, for example, to distinguish between singular and plural forms of nouns. For example, it may be desirable to map “star” to “ [symbol] ” and “stars” “ [symbol] ”.

Emojification can also be performed using the information extraction module 310, which operates as a search and extract tool and uses rank based information extraction and retrieval techniques. Some examples of this approach can be similar to approaches used by existing search engines (e.g., LUCENE/SOLR and SPHINX), which can utilize application program interfaces (APIs) to do fast autocomplete. Such approaches generally require data in a particular format. SOLR, for example, is better suited for document search but scales well, whereas SPHINX is better suited for autocomplete but does not scale well. A typical search engine indexes documents corresponding to search terms so that immediate matching documents can be found for new search terms. Such indexes list or include frequencies of individual terms occurring in documents, with a higher frequency for a given search term indicating a relevant match. A similar approach can be used in the context of words and emoji. For example, if a certain emoji occurs in the context of a given word multiple times, there is a high probability that the word and emoji can be used interchangeably. Accordingly, the information extraction module 310 may suggest an emoji for a particular word or phrase when the emoji has been used frequently in conjunction with or as a substitute for the word or phrase. In one example, a collection of text messages for a messaging platform (e.g., a game platform) can be searched using the information extraction module 310 to identify the frequencies with which certain emoji are used in conjunction with various words or phrases, for the messaging platform.

The natural language processing (NLP) module 312 can also be used for emojification. In general, the NLP module 312 employs NLP tools, such as, for example, parsers, morphological analyzers, sentiment analyzers, semantic analyzers, and the like, to obtain the latent meaning and structure of a chat message. Such information can then be used to match sentences with emoji that are tagged with the respective data. For example, when presented with varying degrees of emotions, sentiment analyzers can identify the extremity of the emotion. Cases like “I am happy” and “I am very happy” can then be identified and different emoji can be assigned to them to better represent the higher or lower degree of emotion represented. The NLP module 312 can analyze content to search for, for example, grammar, named entities, emotions, sentiment, and/or slang. Emoji are identified that match or correspond to the content.

Alternatively or additionally, the keyword matching module 314 can be used for emojification. The keyword matching module 314 preferably performs a simplistic version of information retrieval in which certain keywords (e.g., named entities, verbs, or just non-stopwords) are matched with tags associated with emoji. The stronger the match is between the keywords and the tags, the better the hit-rate will be. For example, a cop car, a police car, and a police cruiser can all be mapped to the same emoji depicting a police car. Each of these named entity variants are recorded as tags for the police car emoji. Alternatively or additionally, the order of the tags and emoji can be flipped such that the police car emoji (e.g., “ [symbol] ”) can be matched to multiple hypotheses, such as “car,” “police car,” and “cop car,” for example. Such hypotheses can be ranked in order of relevance to the given emoji and the hypothesis providing the best match can be identified. In some implementations, output from the keyword matching module 314 is combined with output from other methods used by or included in the emoji detection module 116. N-best hypotheses can be obtained from a plurality of these methods and assembled.

In general, techniques used for the keyword matching module 314 differ from techniques used for the dictionary-based module 306. Dictionary matching generally depends on building a static list of one-to-one correspondences between words and emoji. Keyword matching is an enhancement over dictionaries in a way that multiple keywords such as “cop” and “police” may be associated with each other and then in turn associated with corresponding emoji. In various examples, dictionary matching may have a singular entry for police and the emoji for police. By contrast, keyword matching may teach that “cop” and “police” are the same, thereby improving dictionary coverage.

The finite state transducer (FST) module 316 can also be used for emojification and can help overcome the lack of context information problem of other methods, such as the dictionary-based method. FSTs have certain applications in NLP, for example, in automatic speed recognition (ASR) and machine translation (MT). FSTs generally work at a high speed and are suitable for providing emoji recommendations in real-time or near real-time. FSTs typically work on the basis of state transitions. The generation process is driven off of words or emoji seen in the sentence so far (e.g., a user's partial input). The next step or state in the sentence will then be generated based on transition probabilities learned from a training corpus. In certain examples, the state transitions used by an FST are similar to those used by a Hidden Markov Model in the SMT module 304. A differentiating factor, however, is that the SMT module 304 uses state transitions trained on bilingual data (language-emoji) whereas the FST module 316 uses monolingual data to learn state transitions. The monolingual data includes emojified text as training data, and state transitions effectively are or are based on a probability of a word/emoji following a preceding word/emoji. A generative model is hence built on probability of succession. The FST module 316 can be used to predict emoji that are likely to be inserted after a word or phrase, based on prior usage of emoji following the word or phrase.

The emoji detection module 116 uses one or more of its emoji detection modules (e.g., the dictionary-based module 306 and the POS tagging module 308, although any one or more emoji detection modules can be used) to identify emoji that may be suitable for insertion into a user's communication. In one example, each emoji detection module provides a vector of probabilities or confidence scores. Each probability or confidence score may be associated with one or more candidate emoji and may represent the likelihood that the user may wish to insert the emoji into the communication. Alternatively or additionally, the probability or confidence scores may indicate a correlation between the emoji and the communication. Due to the different methods employed and the information available in the communication, the confidence scores from each emoji detection module may not be consistent.

In general, the emoji detection modules in the emoji detection module 116 can receive various forms of input. For example, depending on the specific method being used, the emoji detection modules can receive (e.g., from a client device) one or more of the following as input: the cursor position in content; a content stream previously input from the user's keyboard in a current instance or session (e.g., from the client device); one or more characters, words, or phrases being typed or entered by the user (e.g., using the keyboard on the client device); the content entered in previous iterations or sessions of using the keyboard before the current instance (e.g., from server logs); user preferences (e.g., preferred emoji or emoji categories); and demographic information (e.g., sender or recipient ethnicity, gender, etc., obtained from server logs). In one example, demographic information can be used to recommend emoji having particular hair types (e.g., to represent gender) or skin types (e.g., for face and skin emoji). Some emoji detection modules may need access to lexicons (e.g., stored on the server system 112), NLP tools (e.g., running and accessible from the server system 112), and/or a content normalization server (e.g., running on the server system 112) that are specific to the functioning of the emoji detection modules. Content normalization servers can be useful in maximizing matches between words and emoji. For example, it is common practice for users of a chat messaging system to use informal language, slang, and/or abbreviations in text messages. In a typical example, the word “luv” can be normalized to “love” by such a server, and the word “love” can then be correctly matched to one or more suitable emoji, such as a heart-shaped emoji (e.g., [symbol] ).

The output from the various emoji detection modules in the emoji detection module 116 can be combined or processed using the emoji classifier module 118 to obtain suggested emoji. The output from multiple emoji detection modules can be provided to the emoji classifier module 118 as a single, combined output or as multiple outputs (e.g., a separate output from each module or method used). In general, the emoji classifier module 118 receives output from the emoji detection module(s) and process the output to obtain suggested emoji, using various techniques. Training data may be used to train the one or more classifiers in the emoji classifier module 118, as described herein.

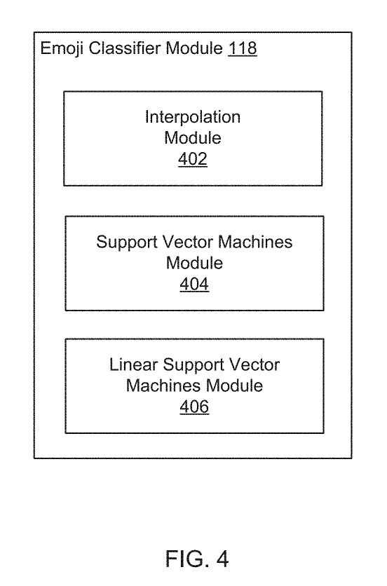

Referring to FIG. 4, the emoji classifier module 118 can include an interpolation module 402, a support vector machines (SVM) module 404, and a linear SVM module 406. Other classifiers or classifier modules can also be used.

The interpolation module 402 can be used to perform an interpolation (e.g., a linear or other suitable interpolation) of the results from two or more emoji detection methods. For example, a set of emoji suggestions can be determined by interpolating between results from the keyword matching module 314 and the SMT module 304. A certain phrase-emoji mapping can have a score k from the keyword matching module 314 based on term frequencies, and a score s from the SMT module 304, for example, based on HMM output probabilities. These scores can then be normalized (e.g., so that a maximum possible score for each module is equal to one) and interpolated to generate a combined score.

In general, the optimal weights for interpolating between two or more values can be determined numerically through trial and error. Different weights can be tried to identify the best set of weights for a given set of messages. In some instances, the weights can be a function of the number of words or characters in the message. Alternatively or additionally, the weights can depend on the linguistic domain of the message. For example, the optimal weights for a gaming environment can be different than the optimal weights for a sports environment.

The SVM (support vector machines) module 404 can be or include a supervised learning model that analyzes combinations of words/phrases and emoji and recognizes patterns. The SVM module 404 can be a multi-class SVM classifier, for example. The SVM classifier is preferably trained on labeled training data. The trained model acts as a predictor for an input. The features selected in the case of emoji detection can be, for example, sequences of words or phrases. Input training vectors can be mapped into a multi-dimensional space. The SVM classifier can then use kernels to identify the optimal separating hyperplane between these dimensions, which will give the classifier a distinguishing ability to predict emoji. The kernel can be, for example, a linear kernel, a polynomial kernel, or a radial basis function (RBF) kernel. Other suitable kernels are possible. A preferred kernel for the SVM classifier is the RBF kernel. After training the SVM classifier using training data, the classifier can be used to output a best set of emoji among all the possible emoji.

The linear SVM module 406 can be or include a large-scale linear classifier. An SVM classifier with a linear kernel may perform better than other linear classifiers, such as linear regression. The linear SVM module 406 differs from the SVM module 404 at the kernel level. There are some cases when a polynomial model works better than a linear model, and vice versa. The optimal kernel can depend on the linguistic domain of the message data and/or the nature of the data.

Other possible classifiers used by the systems and methods described herein include, for example, decision tree learning, association rule learning, artificial neural networks, inductive logic programming, random forests, gradient boosting methods, support vector machines, clustering, Bayesian networks, reinforcement learning, representation learning, similarity and metric learning, and sparse dictionary learning. One or more of these classifiers, or other classifiers, can be incorporated into and/or form part of the emoji classifier module 118.

In various implementations, the classifiers receive as input the probabilities or confidence scores generated by one or more of the emoji detection methods. The probability or confidence scores can correlate a word or a phrase in the user message to one or more possible emoji that the user may wish to insert. Depending on the classifier(s) in use, the classifiers can also receive as input the current cursor position, a word or phrase in the user message, a previous message or previous content sent or received by a user, user preferences, and/or user demographic information. In general, the classifiers use the input to determine a most probable word-emoji mapping, along with a confidence score.

Referring again to FIG. 1, for a given communication, the manager module 120 can select outputs from specific emoji detection methods, classifiers, and/or combinations of emoji detection methods to suggest emoji for insertion into the communication. The manager module 120 can make the selection according to, for example, the linguistic domain, a length of the communication, or a preference of a user. The manager module 120 can select specific classifiers according to, for example, a confidence score determined by the classifiers. For example, the manager module 120 can select the output from the classifier that is the most confident in its prediction. In certain examples, the manager module 120 selects a combination of output from the grammar error correction module 302, the dictionary-based module 306, the part of speech tagging module 308, and/or the natural language processing module 312. Alternatively or additionally, the manager module 120 can select a combination of output from the statistical machine translation module 304 and the finite state transducer module 316. The manager module 120 can combine the output from these modules using one or more classifiers from the emoji classifier module 118, such as the interpolation module 402. Support vector machines classifiers (e.g., in the support vector machines module 404 or the linear support vector machines module 406) can be useful for tying together user information or preferences (e.g., for players of a multi-player online game) with one or more confidence scores from the emoji detection modules 116.

The training data for the classifiers can be or include, for example, the output vectors from different emoji detection methods and an indication of the correct or best emoji for content having, for example, different message lengths, linguistic domains, and/or languages. The training data can include a large number of messages for which the most accurate or preferred emoji are known.

Certain emoji detection methods, such as the grammar error correction method 302 and the statistical machine translation method 304, can be or utilize statistical methods for converting content to emoji. Training data can be collected and utilized to implement these statistical methods.

In an initial test data collection phase, a test set of at least 2000 messages can be collected and used to evaluate different emojification methods, although any suitable number of messages in a test set can be used. In the evaluation, the same metric as grammar error correction can be used. In a second phase, training data can be collected for statistical emojification methods. In a third phase, crowdsourcing can be used to collect large amounts of training data for different languages.

In one implementation, a webpage can be created for collecting training data. A database table can be used to save certain raw chat messages selected from a chat message database. When a user logs into the webpage, content can be shown to the user, and the user can be asked to convert the content into its emojified form. The webpage preferably displays a virtual keyboard of emoji to assist users with the emojification process. Emojified messages from the users are stored in a database. In general, the webpage allows training data to be collected for the emoji detection methods that employ statistical techniques.

To obtain raw messages for users to emojify on the webpage, English phrases can be gathered for each English-emoji pair in an emojification dictionary. A search can then be performed for the phrases in the English chat messages of a chat log database.

In general, crowdsourcing techniques can be used (e.g., within a chat room or gaming environment) to let users match frequently used content with emoji patterns. Crowdsourcing may also be used in reverse. For example, one or more emoji can be presented to users who then provide suggested content corresponding to the emoji.

Alternatively or additionally, crowdsourcing can be used to create new emoji that can be shared with other users. For example, in a gaming environment, the game operator has control over the game economy and has access to a huge player base, which allows the game operator to utilize crowdsourcing for emoji creation. Players can be given access to a tool to design, create, and share emoji with other players, for insertion into messages. The tool can allow players to create emoji by combining pre-defined graphical elements and/or by drawing emoji in free form. Players can be allowed to vote on and/or approve user-created emoji that players find useful, funny, and/or relevant for use in the game environment. This can improve the emoji adoption process, with more highly rated emoji becoming adopted more easily by the players.

The emoji creation process can also be incentivized. For example, game players can earn awards when they create and submit emoji and/or when their emoji are used by other players. The awards can be in nearly any form and include, for example, financial incentives, such as coupons and discounts, and game-related incentives, such as virtual goods or virtual currency for use in a game. Such rewards provide incentives to players to create and share their emoji with the gaming community. The incentives can allow emoji to be created more quickly, for example, when emoji are needed for a seasonal player versus environment (PvE) event.

In general, the creation of emoji by users is not limited to gaming environments. Users of chat rooms or other communication systems can be provided with emoji creation tools and allowed to share their emoji with others. Such crowdsourcing efforts can also be incentivized, with users earning certain rewards (e.g., coupons, discounts, and other financial incentives) in exchange for their emoji creations.

Implementations of the emojification systems and methods described herein are capable of utilizing emoji from various sources, including IOS keyboards, ANDROID keyboards, and/or UNICODE (e.g., available at: http://unicode.org/emoji).

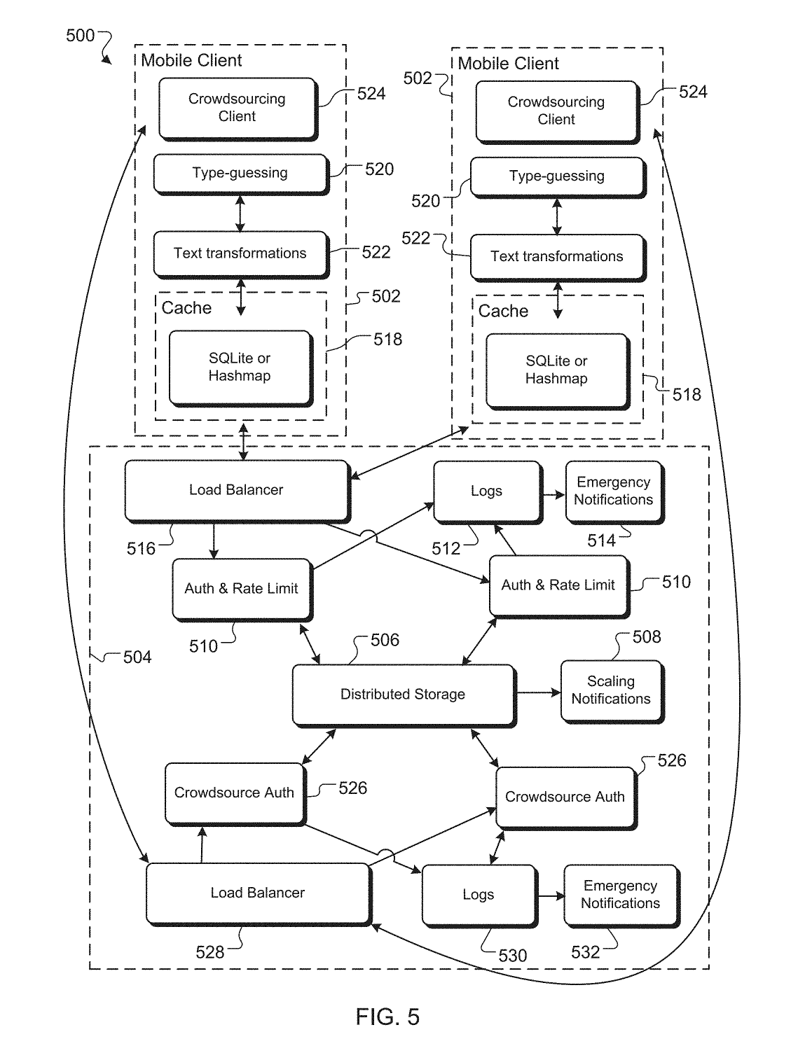

FIG. 5 is an example architecture for an emoji suggestion system 500. The system 500 includes a plurality of client devices 502 interacting with a server module 504 over a network (e.g., the network 132). The server module 504 includes a distributed storage module 506, which serves as a foundation of the system 500. The distributed storage module 506 is a server side data store (e.g., a distributed database) that stores data relevant to emoji-keyword maps, player usage information, player preferences, and other information useful for suggesting emoji. The distributed storage module 506 can be, include, or form part of the training data 122, dictionaries 124, chat histories 126, and/or user information 128 databases. The distributed storage module 506 can provide scaling notifications 508 or alerts to system administrators when the amount of data stored is approaching storage capacity. The server module 504 can be the same as or similar to the server system 112 and/or include some or all of the components of the server system 112. Client devices 502 can include, for example, a personal computer, a smart phone or other mobile device, a tablet computer, and a laptop computer. Client devices 502 can be the same as or similar to one or more of the client devices 134, 136, 138, and 140.

The system 500 also includes one or more authentication and rate limit modules 510 that prevent unauthorized access to the distributed storage module 506. At the same time, data relevant to only a user in question is accessed through the authentication and rate limit module 510, to serve the most relevant emoji to the user. The authentication and rate limit module 510 maintains logs 512 to record transactions and provides emergency notifications 514 to notify system administrators of any errors.

The system 500 also includes a load balancer 516, which serves as an interface between the client devices 502 and the server module 504. The load balancer 516 handles concurrent requests from multiple client devices 502 and ensures each client device 502 is queued and routed to the server module 504 properly.

Each client device 502 includes a local cache module 518, a type-guessing module 520, and a text transformation module 522. The local cache module 518 serves the most frequently used emoji or emoji-keyword maps to a keyboard on each client device. The local cache module 518 can be or can utilize, for example, a hash map, ELASTICSEARCH, and/or SQLite. The type-guessing module 520 and the text transformation module 522 can be used to decode words or phrases to find emoji equivalents. For example, the type-guessing module 520 can predict words or phrases that will be entered next by a user, based on an initial portion of a user message. The type-guessing module can use or include, for example, the FST module 316 and/or the RNNLM language model, described herein. The text transformation module 522 can be used to transform informal content. For example, the text transformation module 522 can convert acronyms, abbreviations, chat speak, and/or profanity to more formal words or phrases, before the content is analyzed to find emoji suggestions. In some implementations, the type-guessing module 520 and/or the text transformation module 522 are implemented in the server module 504. For example, these modules can be located between or near the distributed storage module 506 and the authentication and rate limit module 510.

The client devices 502 and the server module 504 also include crowdsourcing elements that allow players to create new emoji and share the emoji with a community of users. A user can draw or create new emoji using a crowdsourcing client module 524 on the client device 502. The user-created emoji can be transferred to the server module 504 where the user-created emoji is stored in the distributed storage module 506. Crowdsourcing transactions preferably pass through one or more crowdsourcing authentication modules 526, so emoji created by a given user are stored with the user's credentials. Such information can be used later when emoji created by a player are validated and the user is rewarded for creating the emoji. A crowdsourcing load balancer module 528 maintains crowdsourcing logs 530 and provides any emergency notifications 532.

In certain implementations, the emojification systems and methods described herein provide real-time emoji suggestions as users type or enter messages. Real-time suggestions can be facilitated by caching emoji on user client devices. Alternatively or additionally, the emoji detection module 116, emoji classifier module 118, and/or the manager module 120 can be stored on client devices and can be performed by these devices. In some examples, an emoji keyboard can be used in place of a native client keyboard. The emoji keyboard allows players to choose emoji instead of words and/or displays emoji substitutes on top of a content keyboard.

The emojification systems and methods can be configured to fetch emoji suggestions from an ELASTICSEARCH or other suitable server. This can be effective but is generally not efficient in terms of response time, since a server request is required to obtain the emoji suggestions. For example, about 2500 or more content to emoji alignments can be used to make emoji suggestions.

Given this small amount of data, simulating ELASTICSEARCH using, for example, an auto completion indexing environment on the client side is a preferred implementation. This can avoid making an http request to the ELASTICSEARCH server and will generally improve the response time for making emoji suggestions.

Extracted mapping between words/phrases and emoji can be considered to be or form a document and can be outputted to a suitable format, such as, for example, JSON format or the like. The mapping is preferably pushed to the client every time or stored in the client side only with pushing updates, so that a suggestion module (e.g., on a client device) can use it to make suggestions.

On the client side, a document indexing system has two components. One component involves getting input suggestion terms from partial input. The other component involves mapping suggestion terms into a content to emoji mapping document. An input term suggestion system can be modeled as a prefix tree with the input terms in the content to emoji mapping documents in the loaded JSON file from the server side. The second index is preferably an inverted index of terms to document. For each possible set of unique input terms, the documents corresponding to the input terms are mapped.

Also on the client side, an auto completion system is configured to make use of the above indices and determine possible suggestions as a user enters text or other content. The system receives partial input from the user, determines all possible emojifiable content (i.e., content that can be converted into one or more emoji) ending with the partial input, and gets corresponding content to emoji mapping documents. Since suggestions can be obtained on the phrase level, it can be tricky to store the index reference where the emojifiable content actually starts. In particular, the user can go back any time and change the input, which can change the index reference for all other words as well. The system can also maintain a start index offset at every character position in the input. The start index offset can be used to obtain the longest possible emojifiable content at that particular point. The system can also use language model based filtering to filter irrelevant suggestions. The language model can be stored in the client side as a simple hash map of n-gram→(lm_value, back_off_weight) values. For example, the words at the current index position and the preceding words can be compared with a language model probability distribution (lm_value) to measure the probability of their occurrence. If no direct match is found, the back_off_weight values are used as a fallback mechanism. Matches with a low lm_value can be ignored from the selection process, thereby filtering the resulting option of matches.

In general, the client side indexing system should have a much faster response time for making suggestions, when compared to, for example, ELASTICSEARCH requests. Table 2 shows results from a test in which client side and server side systems were evaluated. The ELASTICSEARCH server was hosted in localhost machine. Response times for evaluating 2800 examples are provided in the table. The response time for the client side implementation was about half of the response time for the server side implementation. Client side indexing and auto completion therefore appears to be faster than a server side implementation.

TABLE 2
Response time comparison.

| | Response time per request |
|---|---|
| System | (seconds) |
| ELASTICSEARCH | 0.000860 |
| system | |
| Client side | 0.000436 |
| implementation | |

A goal of emojification is to convert content token(s) into emoji that convey the same meaning as the original input content. In terms of high level system design, there are generally two ways of doing this. One approach is to wait for the user to enter complete content input and emojify the input content using dictionary-based methods and/or statistical methods. A second approach is to treat emojification as an auto complete operation where emoji are suggested when the user is in the process of typing input characters. An advantage of the first approach is that the emojification operation is performed only once at the end. The first approach, however, gives little or no control to the user over how the input content should be emojified. An advantage of the second approach is that it gives the user more control over the emojification process. The main challenge with the second approach is to suggest emoji with incomplete user input in a comparably short time.

To suggest emoji while the user is entering content, one method is to perform an in order query auto complete method in which search terms are evaluated and a suggestion list is produced based on the input search terms. When a user types the search query “j wein,” the results can include a list of suggestions like “j weiner,” “j weiner and associates,” “j weiner photography,” and so on. Such suggestions are obtained by matching complete search terms with the indexed results and populating the highly ranked ones. Some of these web search systems also include auto spelling correction.

Another method of suggesting emoji while the user is entering content is to perform an out of order partial auto complete. This method does not evaluate search terms but evaluates only the prefix of each term to produce a list of emoji suggestions. When a user types “j wein,” the results will be the list of suggestions like “Jeff Weiner,” “Jeff Weinberger,” and so on. To obtain these results, the search term “j wein” is prefix matched with every search terms in the indexed search log, and the one with a highest ranking is retrieved.

Users of the emojification systems and methods described herein generally enter a complete word or modified form of a word before moving on to the next word, rather than entering a single character or two which happens to be the prefix of the search term. The auto completion problem is therefore similar to the “in order query auto complete” method.

In the above-mentioned systems, the complete user input can be considered to be the search term and the search results can be shortlisted based on that. When the user enters a search term, the words that are preceding the current word can be associated and can get some hits in the indexed auto completion log. The input can be completely natural language with successive words not exactly related to each other as in typical search queries. When GOOGLE receives a natural language query, it provides a list of suggestions based on the most frequent prefix and suffix matches of the search query being typed by the user, and sometimes GOOGLE does not suggest anything even if all terms are valid individual terms in the GOOGLE search vocabulary.

With the emojification systems described herein, however, even when there are no emoji to suggest for a complete phrase, there can be an emoji mapping for few words in the phrase. The systems can locate emojifiable words or phrases and rank suggestions among many available suggestions. For example, when a user is typing “police gear” in a search box, emoji suggestions may be available for the words “police man” and “sports gear” separately, but there may be no emoji suggestions for the complete phrase “police gear.” If the user had known there were no specific emoji for “police gear,” the user could have chosen police emoji after entering “police.” When the user types “gear,” it would therefore be better to consider the suggestions for the recent emojifiable content (e.g., the word “police”) as well as suggestions for the current word being typed (e.g., “gear”). This simple example is based on bigrams, but the same problem can be extended to phrases of any length.

Some emoji suggestions can be provided using an ELASTICSEARCH auto completion tool. The tool maintains finite state transducers (FSTs), which can be updated every time during re-indexing rather than during a search time. The tool also stores edge n-grams of every word in an inverted index table. The tool may be, for example, JAVA-based.

Emoji suggestions can also be provided using another JAVA-based tool referred to as CLEO. This tool maintains an index of edge n-grams of search query to search results and uses bloom filters to filter invalid results. In certain examples, the CLEO tool and/or the ELASTIC SEARCH auto completion tool are implementations of or are used by the other methods and modules described herein, including the FST based method and the grammar error correction method.

In certain implementations, indexing a user queries log is an important part of an auto completion system. The emojification systems and methods are preferably capable of re-calculating indices in real-time or near real-time with every user response. The indexing includes a partial search term to complete search term mapping, followed by a complete search term to emoji suggestions mapping.

Examples of the systems and methods described herein can use a statistical language model to calculate the probability of words occurring in a particular sequence, based on statistics collected over a large corpus. The language model can be used, for example, to determine that the probability of “the cow jumped over the moon” is greater than the probability of “jumped the moon over the cow.”

In certain examples, the language model can be used to predict words or other content that a user will type or enter based on partial input (e.g., the beginning of a word or sentence) already provided by the user. When a user starts typing a word, for example, the language model can predict or suggest emoji, based on the partially typed word. The language model can preferably rank any emoji suggestions from a group of possible suggestions, and the highest ranked suggestion can be presented at or near a cursor position, for possible selection by the user. The accuracy of such rankings can vary based on available training data and/or the specific language model used. A preferred language model for the purpose of predicting user input and/or suggesting emoji is or includes a recurrent neural network based language model (RNNLM).

The RNNLM language model generally is or includes an artificial neural network, which makes use of sequential information in data. Each element of input can go through the same set of actions, but the output can depend on previous computations already performed. The model preferably remembers information processed up to a point, for example, using a hidden state at each point, apart from any input and output states. There can theoretically be infinite layers of hidden states in a recurrent neural network.

Traditional neural networks can have an input layer (e.g., a representation of the input), one or more hidden layers (e.g., black boxes where transformation occurs between layers), and an output layer (e.g., a representation of the model output, based on the model input). RNNLM is a specific neural network that can use a single (hidden) layer recurrent neural network to train a statistical language model. RNNLM can use a previous word and a previous hidden state to predict the probability of occurrence of a next word. The current hidden state can be updated with the information processed thus far, for each input element. Training can be performed using, for example, a stochastic gradient descent (SGD) algorithm (or other suitable algorithm), and a recurrent weight from a previous hidden state can be trained using, for example, a back-propagation through time (BPTT) algorithm (or other appropriate algorithm). By predicting a likely next word or phrase that will be entered by a user, the RNNLM is able to suggest one or more emoji that relate to the predicted next word or phrase.

A series of experiments were performed to evaluate the emojification systems and methods. In one experiment, search terms to emoji mappings were indexed in ELASTICSEARCH. A system was also implemented that accesses an ELASTICSEARCH REST API to suggest emoji for any partial input being typed by the user. ELASTICSEARCH can use an in-memory FST and inverted indexing to map search terms to emoji results.

Three different versions of the emoji suggestion system were developed, based on a ranking mechanism being used. In a first version, which uses no ranking, partial input from a user is given directly as an input to the ELASTICSEARCH indexing system. That system, in turn, maps the partial input to possible input queries and returns the list of suggestions. Duplicate suggestions are resolved and no ranking is applied for the suggestion list. The method generally has a good recall rate but poor precision, because it suggests emoji for all partial inputs.

A second, frequency-based ranking version is similar to the first version, although the output suggestion list is ranked or scored based on the frequency of the input query. Duplicate emoji suggestions are resolved by removing lower frequency (e.g., less common) input queries. In one implementation, all possible input queries to the ELASTICSEARCH indexing system are retrieved and the frequency of the input queries in a chat corpus is calculated. Emoji suggestions are preferably ranked based on the calculated frequency score. Compared to the first version, this method generally achieves a higher ranking and comparable precision and recall.

In a third, language model-based ranking version, a tri-gram language model is trained from a chat corpus, and the trained language model is used to filter output emoji suggestions from ELASTICSEARCH. The complete user input, including the most recent character typed by the user, is considered. All possible ELASTICSEARCH input queries for the recent partial input are computed. The recent tri-gram along with the input query is considered as a sentence and is scored using the trained tri-gram language model. The emoji suggestions are ranked based on their likelihood. An appropriate threshold level is set and, if the likelihood of a sentence falls below the threshold, the suggestion is ignored. In certain examples, the first, second, and third versions of the emoji suggestion system utilize one or more of the emoji detection methods and modules described above, such as, for example, the grammar error correction method, the NLP method, the POS method, and/or the dictionary method.

Evaluating the correctness or accuracy of suggested emoji is a highly subjective task. Two important factors in evaluating the correctness of emoji suggestions are precision and recall. Precision generally measures the distraction and/or annoyance experienced by a user due to irrelevant emoji suggestions and/or improper ranking of emoji in the suggestions. Recall generally measures the number of times emoji suggestions have been made and the number of times the user responded to the suggestions positively.

There are three main factors or issues that can cause users to be annoyed by emoji suggestions. One factor is a lack of emoji suggestions. A user may get annoyed, for example, when no emoji suggestions or no accurate emoji suggestions are received for a given user input. Another factor that contributes to user annoyance is the inclusion of inappropriate or inaccurate emoji in a set of emoji suggestions. A user may get annoyed, for example, when all or a portion of the suggested emoji are irrelevant to the user input. A further factor that can lead to user annoyance is an inaccurate or inappropriate ranking of emoji in the set of emoji suggestions. A goal is to place highly ranked emoji at the top of the set of emoji suggestions, where a user can more easily access or identify them. When the highest ranked emoji are inaccurate or inappropriate, however, the user may become annoyed. Users are generally more likely to select the highest ranked emoji in the set.

Certain metrics can be used to measure the annoyance experienced by a user due to the emoji suggestions. In one example, different penalty values are given for the annoyance factors described above, and the penalty values are used to calculate a total penalty for a single suggestion. Because the annoyance level for a user may be a function of the length of user input, penalty values may be computed or scaled according to a length of user input. For example, a user may be more annoyed when incorrect emoji are suggested following lengthy user input, and less annoyed when incorrect emoji are suggested following short or partial user input.

In one example, the total penalty is determined from the sum of a no suggestion penalty (i.e., the penalty associated with providing no emoji suggestions), a wrong suggestion penalty (i.e., the penalty associated with providing incorrect emoji suggestions), and a rank based penalty (i.e., the penalty associated with an incorrect ordering of suggested emoji), across all test examples. The no suggestion penalty can be, for example, 2.0*length factor. The wrong suggestions penalty can be, for example, 1.0*length factor for every wrong suggestion ranked higher than a correct suggestion, and, for example, 0.0*length factor for every wrong suggestion ranked lower than the correct suggestion. Other suitable values for these penalties are possible. The rank based penalty can be, for example, (correct_emoji_suggestion_rank−1)/(number of suggestions)*length factor). The rank based penalty is preferably zero when the correct suggestion is ranked highest and/or when there is no correct emoji suggestion. In this latter case, the “no suggestion penalty” addresses the annoyance issue. The length factor can be a length of current partial user input (e.g., in words) minus a minimum threshold length for suggestion.

In certain implementations, rather than suggesting emoji from a single character of user input, emoji are suggested only after receiving a minimum of a few characters of user input. The minimum threshold for suggesting emoji is preferably two characters, so that only input queries having more than two characters will receive emoji suggestions, although other character lengths for the minimum threshold are possible.

A data set of 2800 examples along with tagged information was prepared and used to evaluate the no ranking method, the frequency-based method, and the language model based ranking method, described herein. The results from the experiment are presented in Table 3 and show that the no ranking method and the frequency based method achieve better recall, because these two methods have no minimum threshold measures or any other filtering criteria. By comparison, the language model based ranking method has a lower recall because a threshold pruning is applied to filter less likely suggestions. The results also show that the language model based ranking method achieves a higher precision and a lower annoyance penalty, compared to the other two methods. The annoyance penalty is lower for the language model based ranking method because much of the annoyance was due to wrong suggestions.

TABLE 3
Evaluation of ranking methods for emoji suggestions.

| | | | Aggregate |
|---|---|---|---|
| | | | Annoyance |
| Method | Precision | Recall | Penalty |
| No ranking method | 0.226 | 0.676 | 86563 |
| Frequency based method | 0.226 | 0.676 | 86252 |
| Language model based ranking | 0.328 | 0.356 | 40102 |

In certain implementations, the systems and methods described herein are suitable for making emoji suggestion available as a service to a plurality of users. Such a service is made possible and/or enhanced by the speed at which the systems and methods suggest emoji, and by the ability of the systems and methods to utilize multiple emoji detection methods and classifiers, based on service requests from diverse clients.

There was no standard representation for emoji until a few years ago. Prior to IOS version 5.0, emoji in IOS devices were encoded using UTF-8 on 3 bytes using SOFTBANK characterset mapping. In IOS version 5.0, IOS devices started using Unified encoding, which is an agreed upon standard among big companies, to represent Emoji characters. With this new format, emoji are all encoded using UTF-8 encoding on 4 bytes.

The mapping of a UNICODE glyph (i.e., the character rendered) to a UNICODE code point does not generally depend on the programming language. Code points are variable in length and can occupy any size from 2 to 4 bytes. Programming languages may process code points differently.

For example, with PYTHON 2.7, looping over a UNICODE object gets one UNICODE code point at a time. PYTHON 2.7 does not support 4-byte UNICODE range expressions as it does for ASCII characters. Writing a UNICODE regular expression to match a range of 4-byte UNICODE codepoint in a UTF-8 encoded UNICODE string may therefore not be possible. But PYTHON 2.7 does support 2-byte UNICODE expressions for UTF-8 encoded UNICODE strings. Looping over a UTF-8 encoded string reads a byte at a time in PYTHON 2.7.

Given this information, experiments were conducted to evaluate the PYTHON 2.7 UNICODE detection process on a sample chat data set. The experiments indicate that when a UTF-8 encoded UNICODE code point has a byte within the range of high or low surrogates, then that byte itself cannot represent a UNICODE character by itself. A meaningful UNICODE representation can be formed when a current byte is combined with a byte having an alternate surrogate pair. Most of the UNICODE code points above the UNICODE character ‘\uFFFF’ are emoji and picture characters. When Chinese, Japanese, and Korean (CJK) and other language scripts are utilized, it is preferable to not approximate all of the code points as emoji.

With PYTHON 2.7 as the programming language, an accurate approach to detect any emoji should be done in two steps. First, iterate through each UNICODE byte of a UTF-8 encoded UNICODE string. If a UNICODE code point is encoded with more than one byte, each of the bytes will have a surrogate pair in it. If a byte does not have a surrogate pair, it should be a UNICODE code point by itself. Second, encode the ranges and the current UNICODE code point and check if the current UNICODE code point falls in that range (e.g., using simple logical comparison).

By contrast, the C++ international components for UNICODE (ICU) API has a very good support to UNICODE range expressions. UNICODE range expressions can be written similarly to ASCII range representation using a hyphen.

Emoji characters are spread across both 2-byte and 4-byte UNICODE ranges. Emoji include ranges of characters listed in Table 4, below.

TABLE 4
UNICODE Ranges and corresponding symbols.

| UNICODE Range | Symbols |
|---|---|
| 2190-21FF | Arrows |
| 2200-22FF | Mathematical Operators |
| 2300-23FF | Miscellaneous Technical |
| 2400-243F | Control Pictures |
| 2440-245F | Optical Character Recognition |
| 2460-24FF | Enclosed Alphanumerics |
| 2500-257F | Box Drawing |
| 2580-259F | Block Elements |
| 25A0-25FF | Geometric Shapes |
| 2600-26FF | Miscellaneous Symbols |
| 2700-27BF | Dingbats |
| +1D100-+1D1FF | Sentiment Emoji |
| +1F000-+1FFFF | Picture Emoji |

The standard list of emoji available on IOS and ANDROID keyboards includes about 900 emoji. Implementations of the systems and methods described herein utilize a greater number of emoji, which allows for a wider range of expressions, events, and language that game players and other users can use to communicate during a game or chat session. In some instances, the emoji can be tagged with content that describes what each emoji represents. The tagging facilitates formation of a list of emoji that may be available for users. For example, emoji tags can be used to identify emoji that are suitable for communications among game players, based on relevance to the game.

In certain examples, the systems and methods described herein can be used to suggest non-word expression items other than emoji for insertion into user communications. The other non-word expression items can include, for example, graphics interchange format (GIF) files and stickers. Such non-word expression items can include descriptive tags that can be associated with one or more words. In preferred implementations, the systems and methods, including the emoji detection module 116 and/or the emoji classifier module 118, are configured to suggest GIFs, stickers, and/or other non-word expression items, in addition to emoji.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. For example, parallel processing can be used to perform multiple emoji detection methods simultaneously. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method of suggesting emoji, the method comprising:
obtaining a plurality of features corresponding to a communication from a user;
providing the features to a plurality of emoji detection modules;
receiving from each emoji detection module a respective output comprising a set of emoji and first confidence scores, each first confidence score being associated with a different emoji in the set and representing a likelihood that the user may wish to insert the associated emoji into the communication;
providing the output from the emoji detection modules to at least one classifier;
receiving from the at least one classifier a proposed set of candidate emoji and second confidence scores, each second confidence score being associated with a different candidate emoji in the proposed set and representing a likelihood that the user may wish to insert the associated candidate emoji into the communication; and
inserting at least one of the candidate emoji into the communication.

2. The method of claim 1, wherein the plurality of features comprise at least one of a current cursor position in the communication, one or more words from the communication, one or more words from a previous communication, a user preference, and demographic information.

3. The method of claim 1, wherein the emoji detection modules comprise at least one of a grammar error correction module, a statistical machine translation module, a dictionary-based module, a part-of-speech tagging module, an information extraction module, a natural language processing module, a keyword matching module, and a finite state transducer module.

4. The method of claim 3, wherein the dictionary-based module is configured to map at least a portion of a word in the communication to at least one corresponding emoji.

5. The method of claim 3, wherein the natural language processing module comprises at least one of a parser, a morphological analyzer, and a semantic analyzer to extend a mapping between words and emoji provided by the dictionary-based module.

6. The method of claim 3, wherein the keyword matching module is configured to search for at least one keyword in the communication and match the at least one keyword with at least one tag associated with emoji.

7. The method of claim 1, wherein at least one of the first confidence scores and the second confidence scores are based on at least one of (i) a user preference, (ii) a linguistic domain, (iii) demographic information, (iv) prior usage of emoji by at least one of the user and a community of users, and (v) prior usage of emoji in prior communications having at least one of a word, a phrase, a context, and a sentiment in common with the communication.

8. The method of claim 1, wherein the at least one classifier comprises at least one of a supervised learning model, a partially supervised learning model, an unsupervised learning model, and an interpolation model.

9. The method of claim 1, wherein the at least one of the candidate emoji is inserted at the current cursor position and replaces at least one word in the communication.

10. The method of claim 1, wherein inserting the at least one of the candidate emoji comprises:
identifying a best emoji having a highest second confidence score in the proposed set of candidate emoji.

11. The method of claim 1, further comprising:
receiving a user selection of at least one of the candidate emoji from the proposed set of candidate emoji; and
building a usage history based on the user selection.

12. The method of claim 1, further comprising:
selecting the at least one classifier based on at least one of the user preferences and the demographic information.

13. A system, comprising:
one or more processors programmed to perform operations comprising:
obtaining a plurality of features corresponding to a communication from a user;
providing the features to a plurality of emoji detection modules;
receiving from each emoji detection module a respective output comprising a set of emoji and first confidence scores, each first confidence score being associated with a different emoji in the set and representing a likelihood that the user may wish to insert the associated emoji into the communication;
providing the output from the emoji detection modules to at least one classifier;
receiving from the at least one classifier a proposed set of candidate emoji and second confidence scores, each second confidence score being associated with a different candidate emoji in the proposed set and representing a likelihood that the user may wish to insert the associated candidate emoji into the communication; and
inserting at least one of the candidate emoji into the communication.

14. The system of claim 13, wherein the plurality of features comprise at least one of a current cursor position in the communication, one or more words from the communication, one or more words from a previous communication, a user preference, and demographic information.

15. The system of claim 13, wherein the emoji detection modules comprise at least one of a grammar error correction module, a statistical machine translation module, a dictionary-based module, an information extraction module, a natural language processing module, a keyword matching module, and a finite state transducer module.

16. The system of claim 13, wherein at least one of the first confidence scores and the second confidence scores are based on at least one of (i) a user preference, (ii) a linguistic domain, (iii) demographic information, (iv) prior usage of emoji by at least one of the user and a community of users, and (v) prior usage of emoji in prior communications having at least one of a word, a phrase, a context, and a sentiment in common with the communication.

17. The system of claim 13, wherein the at least one classifier comprises at least one of a supervised learning model, a partially supervised learning model, an unsupervised learning model, and an interpolation model.

18. The system of claim 13, wherein the at least one of the candidate emoji is inserted at the current cursor position and replaces at least one word in the communication.

19. The system of claim 13, wherein inserting the at least one of the candidate emoji comprises:
identifying a best emoji having a highest second confidence score in the proposed set of candidate emoji.

20. An article, comprising:
a non-transitory computer-readable medium comprising executable instructions, the executable instructions being executable by one or more processors to perform operations comprising:
obtaining a plurality of features corresponding to a communication from a user;
providing the features to a plurality of emoji detection modules;
receiving from each emoji detection module a respective output comprising a set of emoji and first confidence scores, each first confidence score being associated with a different emoji in the set and representing a likelihood that the user may wish to insert the associated emoji into the communication;
providing the output from the emoji detection modules to at least one classifier;
receiving from the at least one classifier a proposed set of candidate emoji and second confidence scores, each second confidence score being associated with a different candidate emoji in the proposed set and representing a likelihood that the user may wish to insert the associated candidate emoji into the communication; and
inserting at least one of the candidate emoji into the communication.
